(19) United States
(12) Patent Application Publication
(10) Pub. No.: US 2025/0275578 A1
(43) Pub. Date: Sep. 4, 2025

(54) AEROSOL GENERATING DEVICE AND HEATING ASSEMBLY

(71) Applicant: SMOORE INTERNATIONAL HOLDINGS LIMITED, George Town (KY)

(72) Inventors: Guo ZHANG, Shenzhen (CN); Lei MA, Shenzhen (CN); Hongming ZHOU, Shenzhen (CN); Rihong LI, Shenzhen (CN); Xianwu DU, Shenzhen (CN); Qingchen CHU, Shenzhen (CN)

(21) Appl. No.: 19/211,114

(22) Filed: May 16, 2025

Related U.S. Application Data
(63) Continuation of application No. PCT/CN2023/114119, filed on Aug. 21, 2023.

(30) Foreign Application Priority Data
Nov. 17, 2022 (CN) 202211442116.1

(51) Int. Cl. A24F 40/46; A24F 40/20; A24F 40/51; A24F 40/57

(52) U.S. Cl. CPC A24F 40/46; A24F 40/51; A24F 40/20; A24F 40/57

(57) ABSTRACT

An aerosol generating device includes: a case with an assembling opening in one end; and a heating assembly detachably mounted in the case so as to heat an aerosol generating substrate. The heating assembly includes a heating structure. The heating structure includes a heating portion for generating infrared light waves in a power-on state, and a sleeve for the infrared light waves to pass through. The heating portion is arranged in the sleeve and is at least partially spaced apart from a tube wall of the sleeve.

### CROSS-REFERENCE TO PRIOR APPLICATION

This application is a continuation of International Patent Application No. PCT/CN2023/114119, filed on Aug. 21, 2023, which claims priority to Chinese Patent Application No. 202211442116.1, filed on Nov. 17, 2022. The entire disclosure of both applications is hereby incorporated by reference herein.

### FIELD

The present disclosure relates to the field of heat-not-burn atomization, and in particular, to an aerosol generating device and a heating assembly.

### BACKGROUND

In the field of HNB (heat-not-burn) atomization, heating methods such as heating through a central heating element heating or a circumferential heating element are generally adopted. The usual approach is that the heating element generates heat, and then the heat is directly transferred to an aerosol generating substrate through thermal conduction. The heating assembly with the heating element is usually fixed inside the aerosol generating device and cannot be disassembled or replaced. After long-term use, it will age, be damaged, and experience surface contamination, resulting in a decrease in the taste quality of the aerosol generated by the heated aerosol generating substrate.

### SUMMARY

In an embodiment, the present invention provides an aerosol generating device, comprising: a case with an assembling opening in one end; and a heating assembly detachably mounted in the case and configured to heat an aerosol generating substrate, wherein the heating assembly comprises a heating structure, wherein the heating structure comprises a heating portion configured to generate infrared light waves in a power-on state, and a sleeve for the infrared light waves to pass through, and wherein the heating portion is arranged in the sleeve and is at least partially spaced apart from a tube wall of the sleeve.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic exploded structural diagram of an aerosol generating device according to a first embodiment of the present disclosure.

FIG. 2 is a cross-sectional diagram of the aerosol generating device in FIG. 1.

FIG. 3 is a schematic structural diagram of a heating assembly of the aerosol generating device in FIG. 1.

FIG. 4 is a first longitudinal cross-sectional diagram of the heating assembly in FIG. 3.

FIG. 5 is a second longitudinal cross-sectional diagram of the heating assembly in FIG. 3.

FIG. 6 is a third longitudinal cross-sectional diagram of the heating assembly in FIG. 3.

FIG. 7 is a schematic exploded structural diagram of the heating assembly in FIG. 3.

FIG. 8 is a schematic bottom structural diagram of the heating assembly in FIG. 3.

FIG. 9 is a transverse cross-sectional diagram of a heating element of the heating assembly in FIG. 3.

FIG. 10 is a transverse cross-sectional diagram of a heating element of an aerosol generating device according to a second embodiment of the present disclosure.

FIG. 11 is a transverse cross-sectional diagram of a heating element of an aerosol generating device according to a third embodiment of the present disclosure.

### DETAILED DESCRIPTION

In an embodiment, the present invention provides an improved aerosol generating device and a heating assembly.

In an embodiment, the present invention provides an aerosol generating device, including a case with an assembling opening in one end, an extractor detachably mounted at the assembling opening and configured to accommodate an aerosol generating substrate, and a heating assembly detachably mounted in the case and configured to heat the aerosol generating substrate.

The heating assembly includes a heating structure; and the heating structure includes a heating portion configured to generate infrared light waves in a power-on state and a sleeve for the infrared light waves to pass through, and the heating portion is arranged in the sleeve and is at least partially spaced apart from the tube wall of the sleeve.

In some embodiments, the aerosol generating device further includes a fixing sleeve arranged in the case in a pluggable manner; and the fixing sleeve is a hollow structure with two ends running through, and the heating assembly is mounted in the fixing sleeve and is detachably arranged in the fixing sleeve.

In some embodiments, the fixing sleeve and the heating assembly are provided with a first connecting structure, and the fixing sleeve and the heating assembly are detachably connected through the first connecting structure.

In some embodiments, the first connecting structure includes a clamping buckle and a clamping hole for cooperating with the clamping buckle;

the clamping buckle is arranged on the heating assembly, and the clamping hole is provided in the side wall of the fixing sleeve and corresponds to the clamping buckle;

or, the clamping hole is provided in the heating assembly, and the clamping buckle is arranged on the inner side wall of the fixing sleeve and corresponds to the clamping hole.

In some embodiments, the fixing sleeve includes a first open end and a second open end spaced apart in the axial direction; and the first open end is configured to arrange the extractor in a partially pluggable manner, and the heating assembly is arranged close to the second open end.

In some embodiments, the first open end of the fixing sleeve is provided with an extension portion for cooperating with the assembling opening; and the extension portion is detachably connected to the case by arranging a second connecting structure.

In some embodiments, the second connecting structure includes a first magnetic member and a second magnetic member, the first magnetic member is arranged on the extension portion, and the second magnetic member is arranged in the case and corresponds to the first magnetic member.

In some embodiments, the extractor includes an accommodating cavity configured to accommodate the aerosol generating substrate, and the heating assembly is at least partially detachably inserted into the accommodating cavity.

The present disclosure further provides a heating assembly, detachably mounted in an aerosol generating device and configured to heat an aerosol generating substrate, and including a supporting base and a heating structure mounted on the supporting base, where the heating structure includes a heating portion configured to generate infrared light waves in a power-on state and a sleeve for the infrared light waves to pass through, the heating portion is arranged in the sleeve and is at least partially spaced apart from the tube wall of the sleeve, the sleeve is provided with an opening, and the opening is provided in the supporting base.

In some embodiments, a first connecting structure detachably connected to the aerosol generating device is provided on the supporting base.

In some embodiments, the heating portion is arranged in the sleeve in a pluggable manner.

In some embodiments, the heating structure includes two conductive portions, and the two conductive portions are connected to the heating portion, led out from the opening, and detachably and electrically connected to the supporting base in a state that the heating structure is mounted on the supporting base.

In some embodiments, conductive members are arranged on the supporting base, and the conductive members correspond to the conductive portions, are detachably connected to the conductive portions, and are electrically connected to the conductive portions in the state that the heating structure is mounted on the supporting base.

In some embodiments, a separating member configured to separate and insulate the two adjacent conductive portions from each other is arranged in the supporting base.

In some embodiments, the supporting base includes a holder configured to support the heating structure;

the holder includes a first holder body and a second holder body arranged in an openable and closable manner; and the first holder body and the second holder body clamp or release the heating structure by closing or opening.

In some embodiments, the supporting base further includes a seal member, the seal member is detachably arranged between the first holder body and the second holder body, and the seal member is detachably and partially sleeved over the heating structure and configured to hermetically connect the heating structure with the first holder body and the second holder body.

In some embodiments, the seal member includes a sleeve body with two ends running through and configured to be partially sleeved over the heating structure, and a first seal portion protruding from the outer side wall of the sleeve body; and

the first seal portion is respectively clamped and fixed with the first holder body and the second holder body.

In some embodiments, the supporting base further includes a shell detachably sleeved over the holder; and

the shell is provided with a through hole for the heating structure to partially penetrate through.

In some embodiments, the seal member includes a sleeve body with two ends running through and configured to be partially sleeved over the heating structure, and a second seal portion protruding from the outer side wall of the sleeve body; and the second seal portion is located between the holder and the shell in an assembled state of the shell and the holder, and is configured to seal a gap formed between the holder and the end surface of the through hole.

In some embodiments, the shell includes a sleeve opening for mounting the holder; and
the holder includes the bottom wall, and a gap is provided between the bottom wall and the sleeve opening in an assembled state of the shell and the holder.

In some embodiments, the holder and the shell are provided with a third connecting structure.

In some embodiments, the third connecting structure includes buckle holes and clamping protrusions; the clamping protrusions protrude from the outer side wall of the holder; and the buckle holes are provided in the side wall of the shell and correspond to the clamping protrusions one to one for clamping with the clamping protrusions.

In some embodiments, the heating assembly further includes a temperature measurement structure arranged on the heating structure and detachably connected to the supporting base.

The present disclosure further provides an aerosol generating device, including the heating assembly in the present disclosure, and a power supply assembly connected to the heating assembly.

The aerosol generating device and the heating assembly in the present disclosure have the following beneficial effects: In the aerosol generating device, by detachably arranging the heating assembly in the case, the overall replacement and cleaning of the heating assembly can be facilitated, thereby improving the taste of the aerosol generated by the heatable aerosol generating substrate.

In addition, the heating portion of the heating structure can generate infrared light waves, and the infrared light waves can pass through the sleeve to reach and heat the aerosol generating substrate. In a case that the highest working temperature of the heating portion reaches 1000° C. or above (the working temperature of traditional HNB heating elements generally does not exceed 400° C.), it will not cause the aerosol generating substrate to be overheated, thereby greatly improving the puffing taste. Moreover, the preheating time is greatly reduced, thereby greatly improving the consumer experience.

To provide a clearer understanding of the technical features, objectives, and effects of the present disclosure, the specific embodiments of the present disclosure will be described below with reference to the drawings.

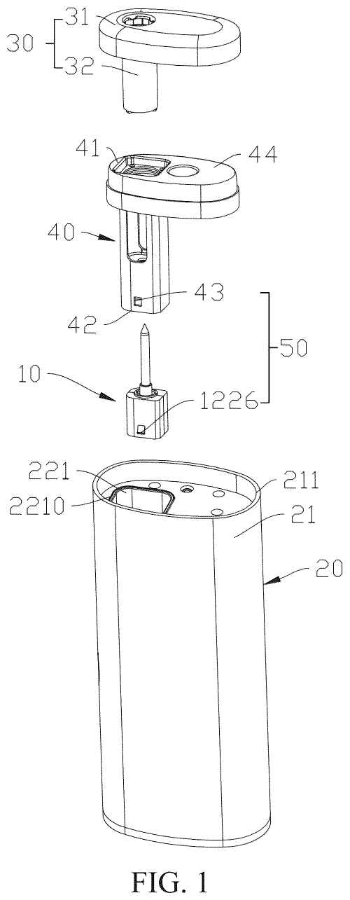

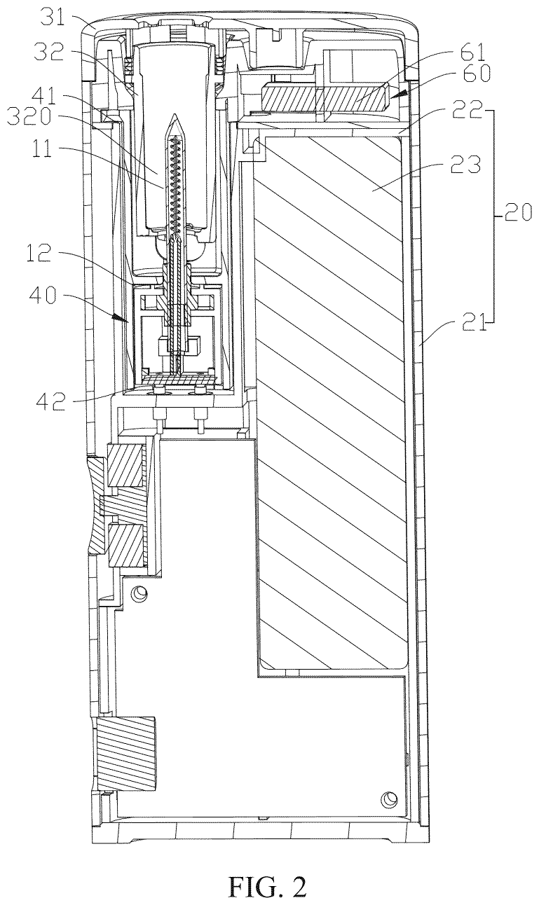

FIG. 1 and FIG. 2 show an aerosol generating device according to a first embodiment of the present disclosure. The aerosol generating device 100 may adopt a low-temperature heat-not-burn method to heat an aerosol generating substrate, and has the advantages of good atomization stability and excellent puffing taste. In some embodiments, the aerosol generating substrate may be arranged in the aerosol generating device 100 in a pluggable manner. The aerosol generating substrate may be cylindrical. Specifically, the aerosol generating substrate may be a filamentous or sheet-like solid material made from leaves and/or stems of plants, and aroma components may be further added to the solid material.

Referring to FIG. 1 and FIG. 2, further, in this embodiment, the aerosol generating device 100 includes a heating assembly 10 and a power supply assembly 20. The heating assembly 10 may be partially inserted into the aerosol generating substrate. Specifically, it may be partially inserted into a substrate section of the aerosol generating substrate, and generates thermal radiation to heat the substrate section of the aerosol generating substrate in a power-on state, causing it to be atomized to generate an aerosol. In this embodiment, the thermal radiation may be thermal infrared radiation. The heating assembly 10 has the advantages of easiness in assembling, simple structure, high atomization efficiency, strong stability, and long service life. The power supply assembly 20 is configured to supply power to the heating assembly 10.

In this embodiment, the heating assembly 10 includes a heating structure 11 and a supporting base 12. The heating structure 11 is mounted on the supporting base 12. In this embodiment, the heating structure 11 and the supporting base 12 are detachably mounted to facilitate the replacement and maintenance of the heating structure 11. The supporting base 12 may be mechanically and electrically connected to the heating structure 11. It can not only support the heating structure 11, but also be electrically connected to the heating structure 11 when the heating structure 11 is mounted on it, thereby electrically connecting the heating structure 11 to the power supply assembly 20. As can be understood, in some other embodiments, the supporting base 12 may only play a supporting role.

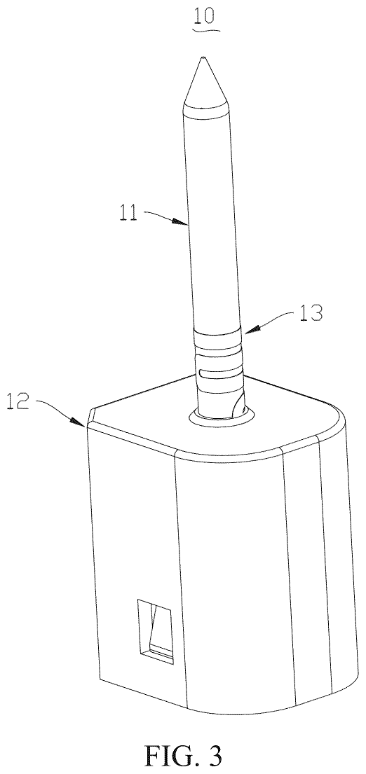

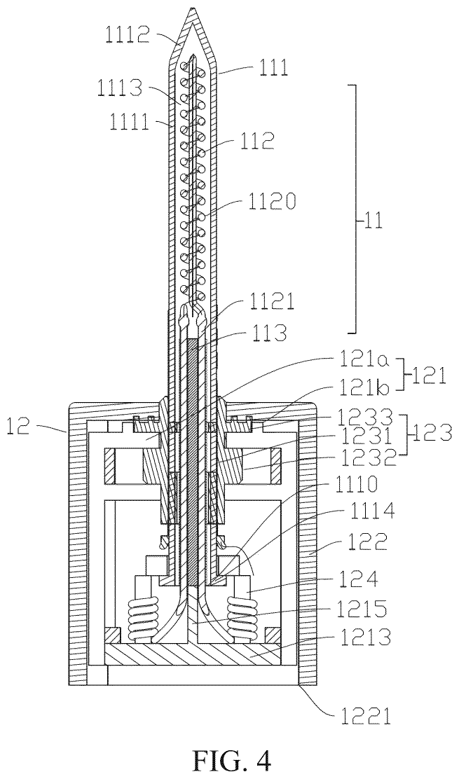

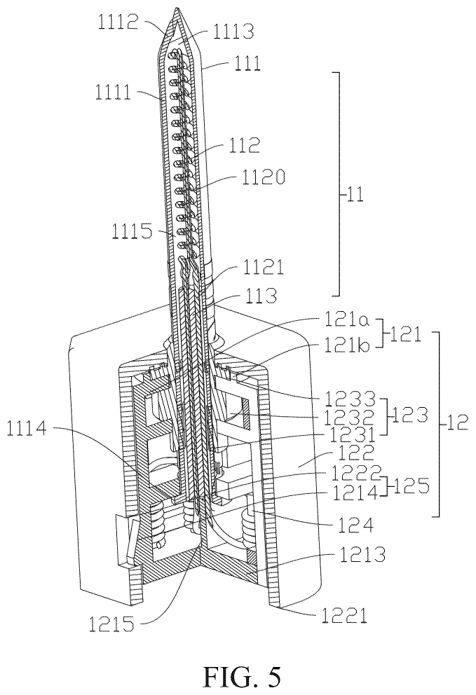

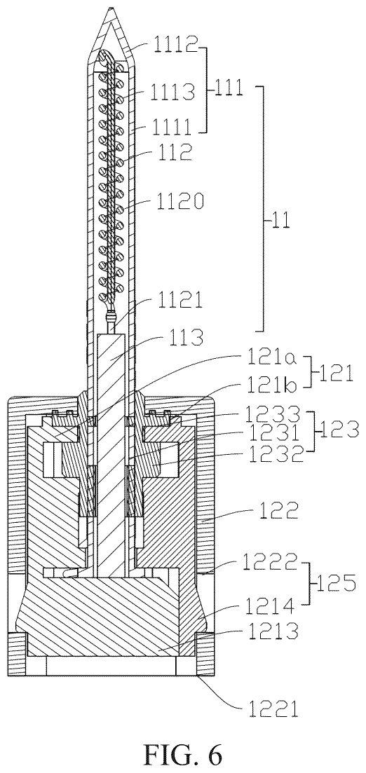

Referring to FIG. 3 to FIG. 6, in this embodiment, the heating structure 11 includes a sleeve 111 and a heating element 112. The sleeve 111 covers at least part of the heating element 112 and may allow light waves to pass through to reach the aerosol generating substrate. Specifically, in this embodiment, the sleeve 111 may allow infrared light waves to pass through, thereby facilitating the heating element 112 to radiate heat to heat the aerosol generating substrate. Specifically, in this embodiment, a gap is provided between the inner wall of the sleeve 111 and the heating element 112. In a power-on state, the heating element quickly heats to increase the temperature to about 1000° C. within 1-3 s, the surface temperature of the sleeve 111 can be controlled below 350° C., and the overall atomization temperature of the aerosol generating substrate is controlled at 300-350° C., thereby achieving the precise atomization of the aerosol generating substrate in a wave band of 2-5 μm. In the present disclosure, the highest working temperature of the heating element ranges from 500° C. to 1300° C., which is much higher than the highest working temperature of the heating element in the existing technology.

In this embodiment, the sleeve 111 may be a quartz glass tube. Of course, as can be understood, in some other embodiments, the sleeve 111 is not limited to a quartz tube and may be any other window material that allows light waves to pass through, such as infrared transparent glass, transparent ceramics, or diamond.

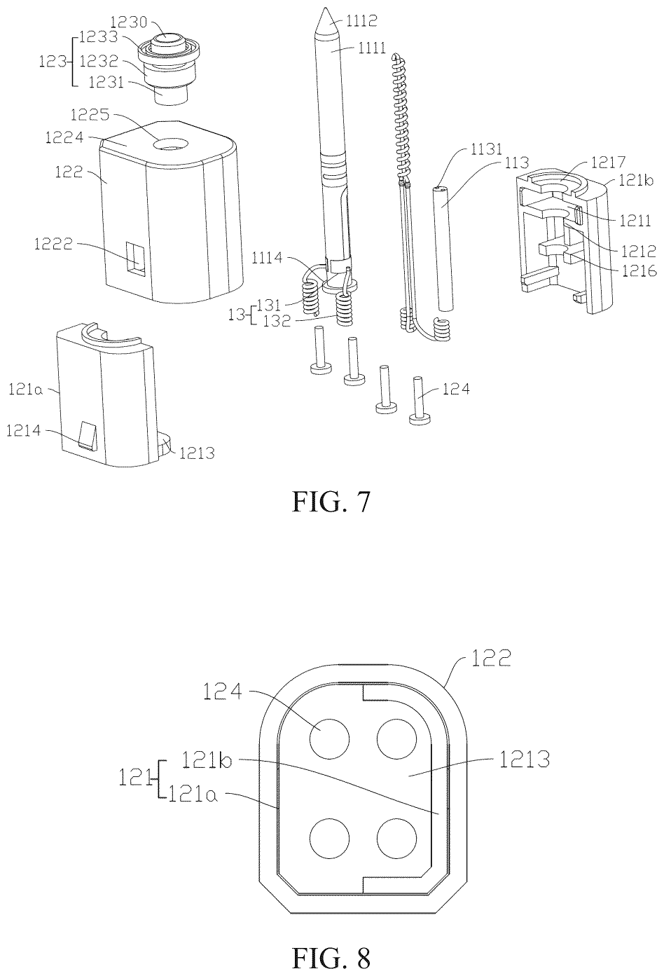

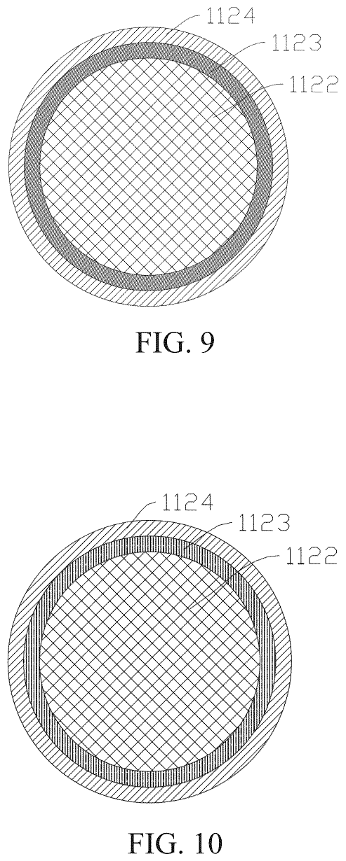

Referring to FIG. 7 to FIG. 9 together, in this embodiment, the sleeve 111 is a hollow tubular body. Specifically, the sleeve 111 includes a tubular body 1111 with a circular cross section, and a pointed structure 1112 arranged at one end of the tubular body 1111. Of course, as can be understood, in some other embodiments, the cross section of the tubular body 111 is not limited to be circular. The tubular body 1111 is a hollow structure with an opening 1110 in one end. The sleeve 111 may be mounted on the supporting base 12. Specifically, the sleeve 111 may be partially inserted into the supporting base 12. Its opening may be located in the supporting base 12. The pointed structure 1112 is arranged at the end of the tubular body 1111 away from the opening 1110. By arranging the pointed structure 1112, it is convenient for at least part of the heating structure 111 to be plugged into the aerosol generating substrate. In this embodiment, an accommodating cavity 1113 is formed on the inner side of the sleeve 111. The accommodating cavity 1113 is a cylindrical cavity and may be non-sealed. When the heating element 112 is mounted in it, the accommodating cavity 1113 does not need to be vacuumed or filled with inert gas. In this embodiment, the sleeve 111 further includes a positioning portion 1114. The positioning portion 1114 is arranged at the opening 1110 of the tubular body 111 and may extend radially outwards along the tubular body 111 to form a positioning flange for the mounting and positioning of the sleeve 111 and the supporting base 12. In this embodiment, the positioning portion 1114 may be integrally formed with the tubular body 111. Of course, as can be understood, in some other embodiments, the positioning portion 1114 may be detachably assembled with the sleeve 111 by sleeving, screwing, or clamping, for example. In this embodiment, an air gap is provided between the inner wall of the sleeve 111 and the heating element 112. The air gap may be filled with air. By providing the air gap, there can be no direct contact between the sleeve 111 and the heating element 112.

In this embodiment, the number of the heating element 112 may be one, which may be longitudinally arranged and wound to form a heating portion 1120 which is spiral on the whole. Specifically, the heating element 112 may be cylindrical on the whole and may be wound to form a single-spiral structure, double-spiral structure, M-shaped structure, N-shaped structure, or structure with any other shape. Of course, as can be understood, in some other embodiments, the number of the heating element 112 is not limited to one, and may be two or more. The shape of the heating element 112 is not limited to a cylindrical shape. In some embodiments, the shape of the heating element 112 may be a sheet shape.

In this embodiment, the heating portion 1120 may be placed in the sleeve 111, spaced apart from the tube wall of the sleeve 111 on the whole, and configured to generate infrared light waves in a power-on state. The infrared light waves may pass through the sleeve 111 to reach the aerosol generating substrate. Of course, as can be understood, in some other embodiments, the heating portion 1120 may also be partially spaced apart from the tube wall of the sleeve 111. In this embodiment, the heating portion 1120 may be in a longitudinally elongated spiral shape. Of course, as can be understood, in some other embodiments, the heating portion 1120 is not limited to a spiral shape.

In this embodiment, one end of the heating portion 1120 is provided with a conductive portion 1121. The conductive portion 1121 is connected to the heating portion 1120, and may be led out from the opening 1110 of the sleeve 111, penetrate through a base, and be electrically connected to the power supply assembly 20. In this embodiment, the conductive portion 1121 may be fixed to the heating portion 1120 through welding to form an integrated structure. Of course, as can be understood, in some other embodiments, the heating portion 1120 may be integrally formed with the conductive portion 1121. In this embodiment, the number of the conductive portions 1121 may be two. The two conductive portions 1121 may be spaced apart, be respectively connected to two ends of the heating portion 1120, extend towards the same end, and penetrate through the sleeve 111 from the opening 1110 in one end of the sleeve 111. In this embodiment, the conductive portion 1121 may be a lead wire, which may be welded to the heating portion 1120. Of course, as can be understood, in some other embodiments, the conductive portion 1121 is not limited to a lead wire and may be any other conductive structure. By arranging the conductive portion 1121 at one end of the heating portion 1120 and leading it out from the sleeve 111, the entire heating structure 11 can be conveniently assembled, thereby simplifying the assembling process. During assembling, the heating structure 11 may be mounted on the supporting base 12, and then enabled to be in contact with a conductive member 124 located in the supporting base 12.

In this embodiment, the heating element 112 forming the heating portion 1120 includes a heating layer 1122 and a thermal radiation layer 1124. The heating layer 1122 may generate heat in a power-on state. The thermal radiation layer 1124 is arranged on the outer surface of the heating layer 1122 and is configured to radiate the heat generated by the heating layer 1122. In this embodiment, the heating layer 1122 and the thermal radiation layer 1124 are concentrically distributed on the cross section of the heating portion 1120.

In this embodiment, the heating layer 1122 may be cylindrical on the whole. Specifically, the heating layer 1122 may be a heating wire. Of course, as can be understood, in some other embodiments, the heating layer 1122 may not be limited to be cylindrical, but may be in a sheet shape, that is, the heating layer 1122 may be a heating sheet. The heating layer 1122 includes a metal substrate with high-temperature oxidation resistance. The metal substrate may be a metal wire. Specifically, the heating layer 1122 may be a nickel-chromium alloy substrate (such as nickel-chromium alloy wire), iron-chromium-aluminum alloy substrate (such as iron-chromium-aluminum alloy wire) or the like made of a metal material with good high-temperature oxidation resistance, high stability, and good deformation resistance. In this embodiment, the radial size of the heating layer 1122 may be 0.15 mm-0.8 mm.

In this embodiment, the heating element 112 further includes an antioxidant layer 1123, and the antioxidant layer 1123 is formed between the heating layer 1122 and the thermal radiation layer 1124. Specifically, the antioxidant layer 1123 may be an oxide film, the heating layer 1122 undergoes high-temperature heat treatment to form a dense oxide film on its own surface, and the oxide film forms the antioxidant layer 1123. Of course, as can be understood, in some other embodiments, the antioxidant layer 1123 is not limited to include an oxide film formed by itself. In some other embodiments, it may be an antioxidant coating layer coated on the outer surface of the heating layer 1122. By forming the antioxidant layer 1123, it can ensure that the heating layer 1122 is not or is rarely oxidized when heated in the air environment, thereby improving the stability of the heating layer 1122. Therefore, there is no need to vacuum, fill inert gas or reducing gas into the first accommodating cavity 1113, nor to seal the opening 1110, thereby simplifying the assembling process of the entire heating structure 11 and reducing the manufacturing cost. In this embodiment, the thickness of the antioxidant layer 1123 may be selectively 1 um-150 um. When the thickness of the antioxidant layer 1123 is less than 1 μm, the heating layer 1122 is easily oxidized. When the thickness of the antioxidant layer 1123 is greater than 150 um, it will influence the heat conduction between the heating layer 1122 and the thermal radiation layer 1124.

In this embodiment, the thermal radiation layer 1124 may be an infrared layer. The infrared layer may be an infrared layer forming substrate formed on the side of the antioxidant layer 1123 away from the heating layer 1122 under high-temperature heat treatment. In this embodiment, the infrared layer forming substrate may be a silicon carbide, spinel, or composite substrate. Of course, as can be understood, in some other embodiments, the thermal radiation layer 1124 is not limited to an infrared layer. In some other embodiments, the thermal radiation layer 1124 may be a composite infrared layer. In this embodiment, the infrared layer may be formed on the side of the antioxidant layer 1123 away from the heating layer 1122 through dip coating, spray coating, brush coating, and other methods. The thickness of the thermal radiation layer 1124 may be 10 um-300 um. When the thickness of the thermal radiation layer 1124 is 10 um-300 um, the thermal radiation effect is better, and the atomization efficiency and taste of the aerosol generating substrate are better. Of course, as can be understood, in some other embodiments, the thickness of the thermal radiation layer 1124 is not limited to 10 um-300 um.

In this embodiment, the heating assembly 11 further includes an insulating member 113, the insulating member 113 is cylindrical, and its radial size may be smaller than the radial size of the accommodating cavity 1113. The insulating member 113 may fully or partially penetrate into the accommodating cavity 1113 through the opening 1110 of the sleeve 111, thereby separating the two conductive portions 1121, that is, insulating the two conductive portions 1121. In this embodiment, the insulating member 113 is provided with through holes 1131, the number of the through holes 1131 is two, the two through holes 1131 correspond to the two conductive portions 1121 one to one, and the through holes 1131 may extend along the axial direction of the insulating member 113 and be configured to allow the conductive portions 1121 to penetrate through for electrical connection with the supporting base 12. In some embodiments, the insulating member 113 may not be limited to be cylindrical. In some embodiments, the insulating member 113 may be an insulating partition, and the through holes 1131 may be omitted. In some embodiments, the insulating member 113 may be a ceramic body, quartz tube, or any other insulating structure.

In this embodiment, the supporting base 12 may support the sleeve 111 and the heating portion 1120, and may be detachably connected to the aerosol generating device by arranging a first connecting structure. The supporting base 12 includes a holder 121, a shell 122, and a seal member 123. The holder 121 is configured to support the heating structure 11. The shell 122 may be sleeved over the outer periphery of the holder 121. The seal member 123 may be mounted on the holder 121 and configured to hermetically connect the heating structure 11 with the holder 121 and the shell 122.

In this embodiment, the holder 121 includes a first holder body 121a and a second holder body 121b that are openable and closable. By arranging the first holder body 121a and the second holder body 121b that are openable and closable, the mounting and dismounting of the heating structure 11 can be facilitated. In some embodiments, splicing the first holder body 121a and the second holder body 121b can form a rectangular solid structure. Of course, as can be understood, in some other embodiments, it is not limited to form a rectangular solid shape by splicing the first holder body 121a and the second holder body 121b. In some other embodiments, splicing the first holder body 121a and the second holder body 121b may form a cylindrical or other shape.

In this embodiment, one end of each of the first holder body 121a and the second holder body 121b is provided with an end plate 1210, separating plates 1212 are correspondingly arranged in both the first holder body 121a and the second holder body 121b, the separating plates 1212 divide the holder 121 into upper and lower spaces, a clamping groove 1211 for cooperating with the seal member 123 is formed in the space close to the end plate 1210, each separating plate 1212 is provided with a semi-cylindrical first avoidance hole 1216, and the two separating plates 1212 of the first holder body 121a and the second holder body 121b are arranged opposite to each other, and the first avoidance holes 1216 are spliced to form a first through hole for the heating structure 11 to pass through.

In this embodiment, the holder 121 further includes the bottom wall 1213, and the bottom wall 1213 is arranged on the first holder body 121a. Of course, as can be understood, in some other embodiments, the bottom wall 1213 is not limited to be arranged on the first holder body 121a, but may also be arranged on the second holder body 121b.

In this embodiment, a separating member 1215 is arranged in the supporting base 12. Specifically, the separating member 1215 protrudes from the bottom wall 1213 and is integrally formed with the bottom wall 1213. It may be a rib plate and be configured to separate the two adjacent conductive portions 1121 and insulate the two conductive portions 1121.

In this embodiment, the first holder body 121a and the second holder body 121b are provided with limiting plate 1216 for limiting the heating structure 11, the limiting plates 1216 are arranged below the separating plates 1212 and are spaced apart from the separating plates 1212, and each limiting plate 1216 is provided with a semi-cylindrical second avoidance hole 1217. When the first holder body 121a and the second holder body 121b are spliced, the two second avoidance holes 1217 in the two limiting plates 1216 are spliced to form a second through hole for the heating structure 11 to pass through. The radial size of the second through hole is smaller than the radial size of the positioning portion 1114 at one end of the sleeve 111, thereby cooperating with the positioning portion 1114 to position the heating structure 11.

In this embodiment, the shell 122 may be sleeved over the outer periphery of the holder 121 after the heating structure 11 is assembled with the holder 121, thereby playing a role of fixing the first holder body 121a and the second holder body 121b, so that the heating structure 11 and the supporting base 12 form an integrated structure. In this embodiment, the shape and size of the shell 122 may be adapted to the holder 121. In this embodiment, the shell 122 is roughly in a rectangular solid shape and is a hollow structure with a sleeve opening 1221 in one end. A gap is provided between the sleeve opening 1221 and the bottom wall 1213, thereby preventing the residual aerosol in the case 21 from condensing and forming condensate that affects the normal operation of the heating structure 11.

In this embodiment, the shell 122 may be detachably connected with the holder 121. Specifically, in this embodiment, the shell 122 and the holder 121 are provided with a third connecting structure 125 and the shell 122 and the holder 121 are detachably connected through the third connecting structure 125. In this embodiment, the third connecting structure 125 includes buckle holes 1222 and clamping protrusions 1214. The clamping protrusions 1214 protrude from the outer side wall of the holder 121. Specifically, the number of the clamping protrusions 1214 is two. The two clamping protrusions 1214 are correspondingly arranged on the outer side walls of the first holder body 121a and the second holder body 121b. The buckle holes 1222 are provided in the side wall of the shell 122 and the number is two. The two buckle holes 1222 correspond to the two clamping protrusions 1214 one to one. When the shell 122 is assembled with the holder 121, the clamping protrusions 1214 can be clamped into the buckle holes 1222, thereby connecting and fixing the shell 122 and the holder 121.

In this embodiment, the side of the shell 122 opposite to the sleeve opening 1221 is provided with a blocking wall 1223, and the shell 122 is provided with a through hole 1224. Specifically, the through hole 1224 is provided in the blocking wall 1223 and can allow the heating structure 11 to partially penetrate through.

In this embodiment, the seal member 123 is detachably arranged between the first holder body 123a and the second holder body 123b, and the seal member 123 is detachably sleeved over the heating structure 11. Specifically, it may be sleeved over the outer periphery of a partial section of the sleeve 111, and configured to hermetically connect the heating structure 11 with the first holder body 121a and the second holder body 121b. In this embodiment, the seal member 123 may be a silica gel member, which serves to prevent vibration and prevent damage when the sleeve 111 and the holder 121 are assembled. Of course, as can be understood, in some other embodiments, the seal member 123 is not limited to a silica gel member.

In this embodiment, the seal member 123 is a hollow structure with two ends running through, a channel 1230 may be formed on the inner side, and the channel 1230 may allow the sleeve 11 to pass through. In this embodiment, the seal member 123 includes a sleeve body 1231, a first seal portion 1232, and a second seal portion 1233. The sleeve body 1231 is cylindrical, is a hollow structure with two ends running through, and is configured to be sleeved over part of the heating structure 11. The first seal portion 1232 and the second seal portion 1233 protrude from the outer side wall of the sleeve body 1231, and are spaced apart along the axial direction of the sleeve body 1231. The first seal portion 1232 may be arranged along the circumferential direction of the sleeve body 1232, and may be roughly in a circular ring shape. The first seal portion 1232 is respectively clamped and fixed with the first holder body 121a and the second holder body 121b. Specifically, the first seal portion 1232 may be respectively clamped into the clamping grooves 1211 in the first holder body 121a and the second holder body 121b. The second seal portion 1233 protrudes from the outer side wall of the sleeve body 1231 and is roughly in a circular ring shape, and its radial size is larger than the radial size of the first seal portion 1232. The second seal portion 1233 may be placed on the side where the end wall 1210 of the first holder body 121a and the second holder body 121b is opposite to the clamping groove 1211. In an assembled state of the shell 12 and the holder 121, the second seal portion 1233 is located between the shell 122 and the holder 121. Specifically, it is located between the blocking wall 1223 and the end wall 1210, and is configured to seal a gap formed between the holder 121 and the end surface of the through hole 1224. In this embodiment, the sleeve body 1231, the first seal portion 1232, and the second seal portion 1233 are an integrally formed structure, forming multiple sealing structures. That is, by arranging the seal member 123, the sealing among the shell 122, the heating structure 11, and the holder 121 can be achieved, thereby simplifying the sealing process, reducing the manufacturing cost, and preventing condensate from flowing into the holder 121.

In this embodiment, multiple conductive members 124 are arranged on the supporting base 12. Specifically, the conductive members 124 are arranged corresponding to the conductive portions 1121 one to one. Of course, as can be understood, in some other embodiments, the number of the conductive member 124 may be one. The conductive member 124 may be an electrode pillar. The multiple conductive members 124 are spaced apart on the bottom wall 1213, and may be detachably connected to the conductive portions 1121. Specifically, in a state that the heating structure 11 is mounted on the supporting base 12, the conductive portion 1121 may be wound around the conductive member 124, thereby being electrically connected to the conductive member 124. In this embodiment, the conductive member 124 may be electrically connected with a power supply in the power supply assembly 20 through contact, thereby electrically connecting the heating structure 11 with the power supply assembly 20 and facilitating the replacement of the heating element 122 when the heating element 112 reaches its service life. In this embodiment, the number of the conductive members 124 is two groups, one group is electrically connected to the heating structure 11, and the other group may be connected to a temperature measurement structure 13. Of course, as can be understood, in some other embodiments, the number of the conductive member 124 may be one group, and the heating structure 11 and the temperature measurement structure 13 may share one group of conductive members 124.

In this embodiment, the heating assembly 10 further includes a temperature measurement structure 13. The temperature measurement structure 13 is arranged on the heating structure 11 and may be detachably connected to the supporting base 12. In this embodiment, the temperature measurement structure 13 may be sleeved over the outer periphery of a partial section of the sleeve 111, and may be detachably connected to the conductive member 124 in the supporting base 12 and electrically connected to it when connected thereto. In this embodiment, the temperature measurement structure 13 is sleeved over a position on the sleeve 111 corresponding to a position of connection between the heating portion 1120 and the conductive portions 1121, and includes a temperature measurement film 131 and lead wires 132. The temperature measurement film 131 may be sleeved over the outer side wall of the sleeve 111. The number of the lead wire 132 is two. The two lead wires 132 are spaced apart, one end of each lead wire is connected to the temperature measurement film 131, the other end of each lead wire may be connected to the conductive member 132 in the supporting base 12, and they may be wound around the corresponding conductive members 132 for electrical connection and signal transmission. In some embodiments, the lead wires 132 may be connected to the temperature measurement film 131 by welding or crimping.

When the heating assembly 10 is assembled, the temperature measurement structure 13 may be first sleeved over the outer periphery of the sleeve 111, and then the seal member 123 is sleeved over the sleeve 111 of the heating structure 11. The first holder body 121a is clamped at the first seal portion 1232 of the seal member 123. Then, the conductive portions 1121 of the heating structure 11 and the lead wires 132 of the temperature measurement structure 13 are wound around the corresponding conductive members 124. Then, the second holder body 121b is clamped at the second seal portion 1232. Finally, the overall structure formed by the holder 121 and the heating structure 11 is inserted into the sleeve opening 1221 in the shell 122, so that the second seal portion 1233 is pressed against the blocking wall 1223 of the shell 122 and the end wall 1210 of the holder 121, the seal member 123 and the heating structure 11 are enabled to partially penetrate through the through hole 1224, and the clamping protrusions 1214 on the outer side of the holder 121 are clamped into the buckle holes 1221 in the shell 122. If the heating structure 11 needs to be disassembled, the shell 122 is pushed out towards the direction of the pointed structure 1112 of the heating structure 11, then the first holder body 121a and the second holder body 121b are separated from the seal member 123, and finally the conductive portions 1121 and the lead wires 132 of the temperature measurement structure 13 are disconnected from the conductive members 124.

In some embodiments, the power supply assembly 20 includes a case 21, a holder 22, and a power supply 23; and the case 21 may be cylindrical, with a hollow structure inside and an assembling opening 211 in one end. The holder 22 is accommodated in the case 21, is configured to mount the power supply 23 and can play a supporting role. The holder 22 is provided with a mounting cavity 221. The mounting cavity 221 may be configured to mount the heating assembly 10. The mounting cavity 221 is communicated with the assembling opening 211 and is provided with a communicating opening 2210 communicated with the assembling opening 211. The power supply 23 is mounted on the holder 22, may be mechanically and/or electrically connected to the heating assembly 10, and is configured to supply power to the heating assembly 10.

In some embodiments, the aerosol generating device further includes an extractor 30, and the extractor 30 may be configured to accommodate the aerosol generating substrate. The extractor 30 may be detachably mounted at the assembling opening 211. In some embodiments, the extractor 30 includes a top cover 31 detachably covering the assembling opening 211, and an accommodating tube 32 with one end connected to the top cover 31. The accommodating tube 32 may be integrally formed with the top cover 31. The accommodating tube 32 may be a structure with two ends running through. An accommodating cavity 320 is formed on the inner side and configured to accommodate the aerosol generating substrate. The heating assembly is at least partially and detachably inserted into the accommodating cavity 320, and may be inserted into the aerosol generating substrate to heat the aerosol generating substrate. The accommodating tube 32 of the extractor 30 is arranged in the mounting cavity 221 in a pluggable manner, and may be pulled out of the case 21 as a whole.

In some embodiments, the aerosol generating device further includes a fixing sleeve 40. The fixing sleeve 40 is arranged in the case 21 in a pluggable manner, may be detachably assembled with the extractor 30, and may form a covering assembly together with the extractor 30. Specifically, the fixing sleeve 40 may be arranged the mounting cavity 221 in a pluggable manner, and may be configured to mount the heating assembly 10. Specifically, the heating assembly 10 is mounted in the fixing sleeve 40 and is detachably arranged in the fixing sleeve 40. In this embodiment, the fixing sleeve 40 is a hollow structure with two ends running through, and includes a first open end 41 and a second open end 42 spaced apart in the axial direction; and a plugging channel configured to allow the extractor to be plugged is formed on the inner side of the fixing sleeve 40. The first open end 41 may be configured to allow the accommodating tube of the extractor 30 to be plugged into the fixing sleeve 40. The heating assembly 10 may be arranged close to the second open end 42 and may be withdrawn from the second open end 42.

In this embodiment, the fixing sleeve 40 and the heating assembly 10 may be detachably connected by arranging a first connecting structure 50. The first connecting structure 50 may include a clamping buckle 1226 and a clamping hole 43. The clamping buckle 1226 may be arranged on the heating assembly 10. Specifically, in this embodiment, the clamping buckle 1226 protrudes from the outer side wall of the shell 12, and the clamping hole 43 is provided in the side wall of the fixing sleeve 40 and corresponds to the clamping buckle 1226. When the heating assembly 10 needs to be mounted into the aerosol generating device, the heating assembly 10 is inserted into the fixing sleeve 40 from the second open end 42 of the fixing sleeve 40, the clamping buckle 1226 is clamped into the clamping hole 43, then it is inserted into the accommodating tube 31 of the extractor 30, and finally the aerosol generating substrate is inserted. When the heating assembly 10 needs to be disassembled or replaced, the extractor 30 and the entire fixing sleeve 40 are pulled out of the mounting cavity 221, then the extractor 30 and the fixing sleeve 40 are separated, then the clamping buckle 1226 is withdrawn from the clamping hole 43, and finally the heating assembly 10 is withdrawn from the second open end 42 of the fixing sleeve 40. In some other embodiments, the clamping buckle 1226 may protrude from the inner wall of the fixing sleeve 40; and the clamping hole 43 may be provided in the heating assembly 10, is specifically located in the side wall of the shell 12 of the heating assembly 10, and corresponds to the clamping buckle 1226 for clamping with the clamping buckle 1226. Of course, as can be understood, in some other embodiments, the first connecting structure 50 may not be limited to a clamping structure. In some other embodiments, the first connecting structure 50 may be a magnetic attraction structure, a threaded structure, a guide slider and sliding groove fitting structure, or any other structure.

In this embodiment, the first open end 41 of the fixing sleeve 40 is provided with an extension portion 44, the extension portion 44 may extend radially outwards along the first open end 41, and its shape and size may be adapted to the shape and size of the assembling opening. The extension portion 44 may cover the assembling opening. The extension portion 44 may also be detachably connected to the top cover 31 of the extractor 30 by clamping or magnetic attraction.

In this embodiment, the fixing sleeve 40 and the case 21 may be detachably connected by arranging a second connecting structure 60. In this embodiment, the second connecting structure 60 includes a first magnetic member 61 and a second magnetic member, the first magnetic member 61 is arranged on the extension portion 44, and the second magnetic member is arranged in the case 21, corresponds the first magnetic member 61, is mounted on the holder 22, and may be integrally formed on a top wall of the holder 22. Of course, as can be understood, in some other embodiments, the second magnetic member may also be arranged independently of the holder 22. When the fixing sleeve 40 is inserted into the mounting cavity 221 of the holder 22, the fixing sleeve 40 may be fixed at the assembling opening 211 of the case 21 through the first magnetic member 61 and the second magnetic member. As can be understood, in some other embodiments, the second connecting structure 60 is not limited to a magnetic structure, and may be a clamping structure, a threaded structure or any other structure.

FIG. 10 shows an aerosol generating device according to a second embodiment of the present disclosure, the difference between the second embodiment and the first embodiment lies in that the thermal radiation layer 1124 is a composite infrared layer. The composite infrared layer may be formed by compounding an infrared layer forming substrate with a bond configured to bond with the antioxidant layer 1123. Specifically, the bond may be glass powder. The composite infrared layer may be a glass powder composite infrared layer. The reason for adopting glass powder is that glass powder can melt at high temperatures to bond the antioxidant layer 1123 with the infrared layer forming substrate and block the gap in the infrared layer forming substrate, thereby further improving the breakdown resistance. The glass powder composite infrared layer may be prepared by adding glass powder to the infrared layer forming substrate (such as silicon carbide or spinel), performing compounding, then coating the mixture onto the side of the antioxidant layer 1123 away from the heating layer 1122 through dip coating, spray coating or brush coating, performing heat treatment in a tunnel furnace, then placing the obtain material in a heating furnace, increasing the temperature to 1000-1200° C. according to certain temperature increase speed, preserving the heat, and then cooling to room temperature with the furnace.

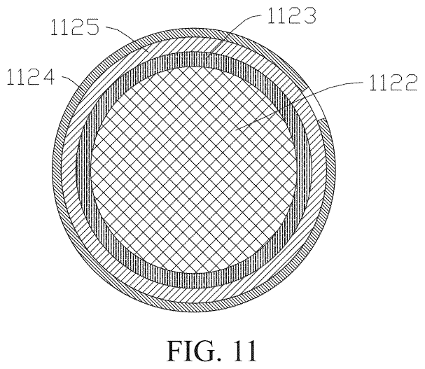

FIG. 11 shows an aerosol generating device according to a third embodiment of the present disclosure, the difference between the third embodiment and the first embodiment lies in that the heating element 112 further includes a bonding layer 1125 arranged between the antioxidant layer 1123 and the thermal radiation layer 1124. The bonding layer 1125 may be configured to prevent the heating layer 1122 from being broken down locally, thereby further improving the bonding strength between the antioxidant layer 1123 and the thermal radiation layer 1124. In some embodiments, the bond in the bonding layer 1125 may be glass powder, that is, the bonding layer 1125 may be a glass powder layer.

In some embodiments, the bond may also be added to the thermal radiation layer 1124, and the melting point of the glass powder selectable for the bonding layer 1125 is higher than the melting point of the glass powder in the thermal radiation layer 1124.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. An aerosol generating device, comprising:
a case with an assembling opening in one end; and
a heating assembly detachably mounted in the case and configured to heat an aerosol generating substrate,
wherein the heating assembly comprises a heating structure,
wherein the heating structure comprises a heating portion configured to generate infrared light waves in a power-on state, and a sleeve for the infrared light waves to pass through, and
wherein the heating portion is arranged in the sleeve and is at least partially spaced apart from a tube wall of the sleeve.

2. The aerosol generating device of claim 1, further comprising:
a fixing sleeve arranged in the case in a pluggable manner,
wherein the fixing sleeve comprises a hollow structure with two ends running through, and
wherein the heating assembly is mounted in the fixing sleeve and is detachably arranged in the fixing sleeve.

3. The aerosol generating device of claim 2, wherein the fixing sleeve and the heating assembly are provided with a first connecting structure, and
wherein the fixing sleeve and the heating assembly are detachably connected through the first connecting structure.

4. The aerosol generating device of claim 3, wherein the first connecting structure comprises a clamping buckle and a clamping hole configured to cooperate with the clamping buckle,
the clamping buckle is arranged on the heating assembly, and the clamping hole is provided in a side wall of the fixing sleeve and corresponds to the clamping buckle,
or, the clamping hole is provided in the heating assembly, and the clamping buckle is arranged on an inner side wall of the fixing sleeve and corresponds to the clamping hole.

5. The aerosol generating device of claim 2, further comprising:
an extractor detachably mounted at the assembling opening and configured to accommodate the aerosol generating substrate,
wherein the fixing sleeve comprises a first open end and a second open end spaced apart in an axial direction,
wherein the first open end is configured to arrange the extractor in a partially pluggable manner, and
wherein the heating assembly is arranged close to the second open end.

6. The aerosol generating device of claim 5, wherein the first open end of the fixing sleeve is provided with an extension portion configured to cooperate with the assembling opening, and
wherein the extension portion is detachably connected to the case by arranging a second connecting structure.

7. The aerosol generating device of claim 6, wherein the second connecting structure comprises a first magnetic member and a second magnetic member,
wherein the first magnetic member is arranged on the extension portion, and
wherein the second magnetic member is arranged in the case and corresponds the first magnetic member.

8. The aerosol generating device of claim 5, wherein the extractor comprises an accommodating cavity configured to accommodate the aerosol generating substrate, and
wherein the heating assembly is at least partially detachably inserted into the accommodating cavity.

9. A heating assembly detachably mounted in an aerosol generating device and configured to heat an aerosol generating substrate, the heating assembly comprising:
a supporting base; and
a heating structure mounted on the supporting base,
wherein the heating structure comprises a heating portion configured to generate infrared light waves in a power-on state and a sleeve for the infrared light waves to pass through,
wherein the heating portion is arranged in the sleeve and is at least partially spaced apart from a tube wall of the sleeve,
wherein the sleeve is provided with an opening, and
wherein the opening is provided in the supporting base.

10. The heating assembly of claim 9, wherein a clamping buckle detachably connected to the aerosol generating device is provided on the supporting base.

11. The heating assembly of claim 9, wherein the heating portion is arranged in the sleeve in a pluggable manner.

12. The heating assembly of claim 9, wherein the heating structure comprises two conductive portions, and
wherein the two conductive portions are connected to the heating portion, led out from the opening, and detachably and electrically connected to the supporting base in a state that the heating structure is mounted on the supporting base.

13. The heating assembly of claim 12, wherein conductive members are arranged on the supporting base, and
wherein the conductive members correspond to the conductive portions, are detachably connected to the conductive portions, and are electrically connected to the conductive portions in the state that the heating structure is mounted on the supporting base.

14. The heating assembly of claim 12, wherein a separating member configured to separate and insulate the two adjacent conductive portions from each other is arranged in the supporting base.

15. The heating assembly of claim 9, wherein the supporting base comprises a holder configured to support the heating structure,
wherein the holder comprises a first holder body and a second holder body arranged in an openable and closable manner, and
wherein the first holder body and the second holder body are configured to clamp or release the heating structure by closing or opening.

16. The heating assembly of claim 15, wherein the supporting base comprises a seal member detachably arranged between the first holder body and the second holder body, and
wherein the seal member is detachably and partially sleeved over the heating structure and configured to hermetically connect the heating structure with the first holder body and the second holder body.

17. The heating assembly of claim 16, wherein the seal member comprises a sleeve body with two ends running through and is configured to be partially sleeved over the heating structure,
wherein a first seal portion protrudes from an outer side wall of the sleeve body, and
wherein the first seal portion is respectively clamped and fixed with the first holder body and the second holder body.

18. The heating assembly of claim 16, wherein the supporting base comprises a shell detachably sleeved over the holder, and
wherein the shell is provided with a through hole for the heating structure to partially penetrate through.

19. The heating assembly of claim 18, wherein the seal member comprises a sleeve body with two ends running through, the seal member being configured to be partially sleeved over the heating structure,
wherein a second seal portion protrudes from an outer side wall of the sleeve body, and
wherein the second seal portion is located between the holder and the shell in an assembled state of the shell and the holder, and is configured to seal a gap formed between the holder and the end surface of the through hole.

20. The heating assembly of claim 18, wherein the shell comprises a sleeve opening configured to mount the holder,
wherein the holder comprises the bottom wall, and
wherein a gap is provided between the bottom wall and the sleeve opening in an assembled state of the shell and the holder.

21. The heating assembly of claim 18, wherein the holder and the shell are provided with a third connecting structure,
wherein the third connecting structure comprises buckle holes and clamping protrusions,
wherein the clamping protrusions protrude from the outer side wall of the holder, and
wherein the buckle holes are provided in a side wall of the shell and correspond to the clamping protrusions one to one for clamping with the clamping protrusions.

22. The heating assembly of claim 9, further comprising:
a temperature measurement structure arranged on the heating structure and detachably connected to the supporting base.
